(19) United States
(12) Patent Application Publication
(10) Pub. No.: US 2026/0212520 A1
(43) Pub. Date: Jul. 23, 2026

(54) META-LENS ARRAY FOR PLENOPTIC CAMERA

(71) Applicant: QUALCOMM Incorporated, San Diego, CA (US)

(72) Inventors: Matthieu Jean Olivier DUPRE, La Jolla, CA (US); Ioannis NOUSIAS, San Diego, CA (US); Sergiu Radu GOMA, Sedona, AZ (US); Jian MA, San Diego, CA (US); Biay-Cheng HSEIH, Irvine, CA (US)

(21) Appl. No.: 19/157,329

(22) PCT Filed: Mar. 8, 2024
(86) PCT No.: PCT/US2024/019237

§ 371 Date: Aug. 15, 2025

(30) Foreign Application Priority Data
Mar. 15, 2023 (GR) 20230100213

(51) Int. Cl. G06T 7/557; G02B 3/08; H04N 23/55; H04N 23/957; H04N 25/79

(52) U.S. Cl. CPC G06T 7/557; G02B 3/08; H04N 23/55; H04N 23/957; H04N 25/79; G06T 2207/10052

(57) ABSTRACT

Systems and techniques are provided for imaging processing. For instance, a process can include obtaining image data for a scene from an image sensor, wherein the image data includes image information for a plurality of sub-images, and wherein the image sensor is configured to obtain images using a meta-lens array including a plurality of meta-lenses; determining depth information for the scene based on the image information for the plurality of sub-images; and outputting information based on the determined depth information.

### FIELD

The present disclosure generally relates to optical systems utilizing meta-lenses. In some examples, aspects of the present disclosure are related to systems and techniques related to meta-lens assemblies.

### BACKGROUND

Many devices and systems include optical elements, such as lenses for focusing light onto an image sensor. For example, a camera or a device including a camera with such optical elements can capture a frame or a sequence of frames of a scene (e.g., a video of a scene). In order to achieve desirable optical characteristics (e.g., including but not limited to sharpness, wide field of view, among others), the camera or camera device can utilize refractive lenses to focus incoming light onto an optical sensor. In some cases, a lens for a camera device can be a compound lens that includes multiple refractive lens elements stacked together. In some cases, the overall thickness of the compound lens stack can add additional size to a device that includes the compound lens stack.

Meta-lenses can provide an alternative to refractive lenses. Meta-lenses can be formed by fabricating nanometer scale (also referred to herein as nanoscale) geometric structures on a substrate material. The nanoscale geometric structures can control the transmission, polarization, and phase of light passing through the nanoscale geometric structures based on physical characteristics (e.g., height, width, length, diameter, etc.) of the nanoscale geometric structures. In some cases, meta-lenses can be fabricated using a fabrication technique, such as electron beam (e-beam) lithography.

### SUMMARY

In some examples, systems and techniques are described for meta-lens cameras. According to at least one illustrative example, an apparatus is provided. The apparatus includes a meta-lens array including a plurality of meta-lenses; an image sensor configured to obtain images using the meta-lens array; at least one memory; and at least one processor coupled to the at least one memory. The at least one processor is configured to: obtain image data for a scene from the image sensor, wherein the image data includes image information for a plurality of sub-images; determine depth information for the scene based on the image information for the plurality of sub-images; and output information based on the determined depth information

As another example, a method for image processing is provided. The method includes: obtaining image data for a scene from an image sensor, wherein the image data includes image information for a plurality of sub-images, and wherein the image sensor is configured to obtain images using a meta-lens array including a plurality of meta-lenses; determining depth information for the scene based on the image information for the plurality of sub-images; and outputting information based on the determined depth information.

In another example, a non-transitory computer-readable medium having stored thereon instructions is provided. The instructions, when executed by at least one processor, cause the at least one processor to: obtain image data for a scene from an image sensor, wherein the image data includes image information for a plurality of sub-images, and wherein the image sensor is configured to obtain images using a meta-lens array including a plurality of meta-lenses; determine depth information for the scene based on the image information for the plurality of sub-images; and output information based on the determined depth information.

As another example, an apparatus for image correction is provided. The apparatus includes: means for obtaining image data for a scene from an image sensor, wherein the image data includes image information for a plurality of sub-images, and wherein the image sensor is configured to obtain images using a meta-lens array including a plurality of meta-lenses; means for determining depth information for the scene based on the image information for the plurality of sub-images; and means for outputting information based on the determined depth information.

In some aspects, one or more of the apparatuses described above is, is part of, or includes a mobile device (e.g., a mobile telephone or so-called “smart phone” or other mobile device), a wearable device (e.g., a smartwatch, a fitness tracking device, etc.), an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, the apparatus includes a camera or multiple cameras. In some aspects, the apparatus includes one or more displays for displaying one or more images, notifications, and/or other displayable data. In some aspects, the apparatus can include one or more sensors, which can be used for determining a location and/or pose of the apparatus, a state of the apparatus, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a perspective view of an example meta-lens, in accordance with some examples;

FIG. 1B is a lateral view of an example meta-lens, in accordance with some examples;

FIG. 1C is a perspective view of an example meta-lens unit cell, in accordance with some examples;

FIG. 1D is a top-down view of an example meta-lens unit cell, in accordance with some examples;

FIG. 1E illustrates a plot of pillar diameter against phase, in accordance with some examples;

FIG. 1F illustrates an example meta-lens having a triangular lattice unit cell, in accordance with some examples;

FIG. 2A illustrates a plot of pillar position against phase, in accordance with some examples;

FIG. 2B illustrates a plot of pillar position against diameter, in accordance with some examples;

FIG. 2C illustrates an example ray diagram for a hyperbolic meta-lens, in accordance with some examples;

FIG. 2D illustrates an example ray diagram for an optimized meta-lens, in accordance with some examples:

FIG. 2E illustrates an example spot diagram at the focal plane for a hyperbolic meta-lens, in accordance with some examples;

FIG. 2F illustrates an example spot diagram at the focal plane for an optimized meta-lens, in accordance with some examples;

FIG. 3 is a diagram illustrating example magnified portions of a meta-lens, in accordance with some examples;

FIG. 4 are diagrams illustrating lateral views of a compound lens and a corresponding meta-lens, in accordance with some examples;

FIG. 5 illustrates a lateral view of an imaging system 500 including a meta-lens array, in accordance with aspects of the present disclosure;

FIG. 6 illustrates a lateral view of an imaging system 600 including a meta-lens array with multi-layer meta-lenses, in accordance with aspects of the present disclosure;

FIG. 7 is a flow diagram illustrating a process for generating an image using a meta-lens array, in accordance with aspects of the present disclosure;

FIG. 8 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Many devices and systems include optical elements, which can include lenses for focusing light onto an image sensor. In one example, a camera or a device including a camera (e.g., a mobile device, an extended reality (XR) device, etc.) with optical elements can capture a frame or a sequence of frames of a scene (e.g., a video of a scene). In order to achieve desirable optical characteristics (e.g., sharpness, wide field of view, etc.), the camera or camera device can utilize refractive lenses to focus incoming light on an image sensor. In some cases, a lens for a camera device can include compound lens comprising multiple refractive lens elements stacked together. In some cases, the overall thickness of the compound lens stack can add additional size to a device that includes the camera lens stack as part of a camera system.

In contrast to a refractive lens, a meta-lens is a lens made with meta-surface technology. A meta-surface is a flat optical component designed at the nanometer (nm) scale with small geometrical features on the surface. In some cases, the small geometrical features can control the transmission, polarization, and phase of light passing through the meta-lens. In one illustrative example, the small geometric features making up a meta-lens can include pillars or columns (sometimes referred to as nanopillars). In some cases, the effect on light passing through the pillars can depend on the geometry of the pillars such as the height of the pillars, diameter of the pillars, and pitch of the pillars. In some implementations, the pillars can have a constant height and the effect on light passing through the pillars can be varied by providing pillars with different diameters.

In some cases, meta-lenses may be used in devices, such as wearable devices or XR devices which may benefit from sensors which may provide information about the environment while, at the same time, prioritizing a small size and thinness. As meta-lenses imaging system can be substantially smaller than comparable conventional lens imaging systems, multiple meta lens imagining systems may be included in place of a single conventional lens imaging system. For example, a conventional lens imaging system with a single lens stack may be used with an imaging sensor of a certain size to produce a single view of an environment. In some cases, an array of multiple meta-lenses may be used be with a same sized imaging sensor to provide multiple views of the environment.

Systems, apparatuses, processes (also referred to as methods), and computer-readable media (collectively referred to as “systems and techniques”) are described herein for a meta-lens array. Rather than using a single meta-lens and corresponding image sensor, a plurality of meta-lenses may be arranged into a meta-lens array and used with as single image sensor. Such an arrangement may be used to generate a single image with multiple sub-images, where each sub-image provides a different view of the environment. These different views may be processed to obtain information about the environment, such as depth information or information about a light field of the environment. This depth or light field information may provide more information about the environment than may be obtainable from a single image. In addition, light field information may allow a resulting light field image to be in focus across the image, which may provide clearer information for image processing functions.

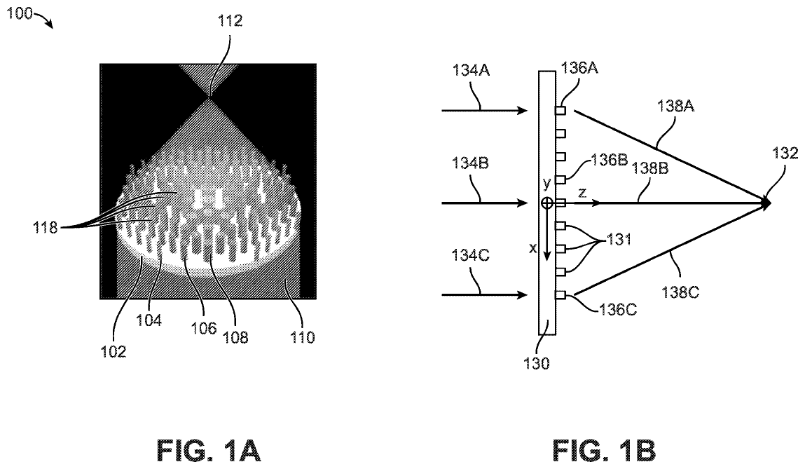

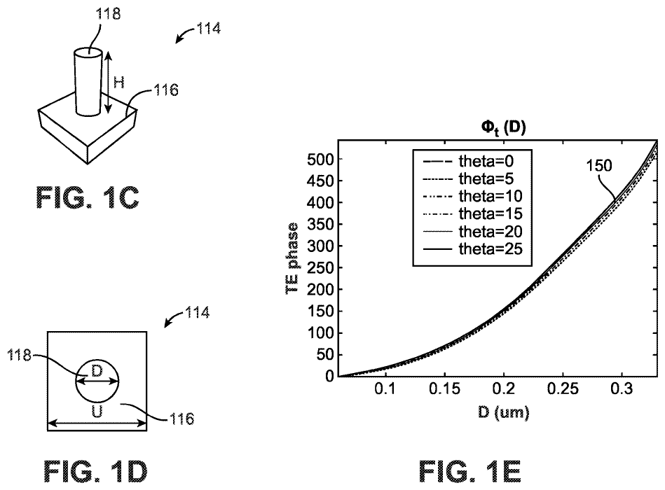

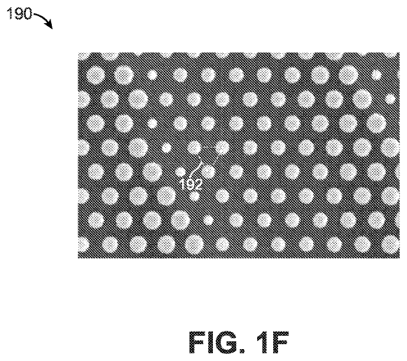

Various aspects of the techniques described herein will be discussed below with respect to the figures. FIG. 1A through FIG. 1C illustrate views of an example meta-lens. In the illustrated example of FIG. 1A, a meta-lens 100 includes a substrate 102 (also referred to as a base) having multiple pillars 118 including pillars 104, 106, 108 disposed on the surface of the substrate 102. In some cases, the pillars 118 can be an example of nanoscale geometric structures forming a meta-surface. The pillars 104, 106, 108 can be nanostructures having a height on the nanometer scale. In some implementations, the height of the nanostructures (e.g., pillars 118) can be on the order of the wavelength of light relevant to a particular application. In one illustrative example, a pillar height between 1100 nanometer (nm) and 1200 nm can be used for a meta-lens in a short range infra-red (SWIR) application (e.g., for wavelengths between 1000 nm and 3000 nm). In another illustrative example, a pillar height between 300 nm and 400 nm can be used for a meta-lens in a visible light application (e.g., for wavelengths between 350 nm and 800 nm) In some implementations, the pillars 104, 106, and 108 can have a common height H. In the illustrated example of FIG. 1A, the pillars 104, 106, 108 can have different diameters, where the pillar 104 is shown with the smallest diameter, the pillar 106 is shown with a diameter larger than the pillar 104, and the pillar 108 is shown with a diameter larger than pillar 104 and pillar 106. In the illustration of FIG. 1A, additional pillars of different sizes disposed on the substrate 102 are also shown. FIG. 1A illustrates a column of light 110 incident upon the meta-lens 100. As will be explained in more detail below, the pillars of the meta-lens 100, including pillars 104, 106, 108 can shift the phase of the rays of the column of light 110 so that the rays of the incident column of light 110 converge to a focal point 112 with a common phase. In some cases, the column of light is collimated. In some cases, the distance between the meta-lens 100 and the focal point 112 can be referred to as the focal distance of the meta-lens 100. While the examples of this disclosure include example meta-lenses utilizing pillars 118 as the geometric features forming a meta-surface that forms the meta-lens, the systems and techniques described herein can be used with meta-lenses that include features other than pillars without departing from the scope of the present disclosure.

FIG. 1B illustrates a lateral view of an example meta-lens 130 that can be configured to focus light at a focal point 132. In some cases, the meta-lens 130 can include a plurality of pillars 131 (which can correspond to pillars 118 shown in FIG. 1A) on one surface of the meta-lens 130. The pillars 118 illustrated in FIG. 1B are shown for illustration are not shown to scale. In addition, the number, height, diameter, and/or pitch of the pillars 118 shown in FIG. 1B are only provided as an example. Other meta-lens configurations can be used without departing from the scope of the present disclosure. For example, each individual pillar of the pillars 118 shown in FIG. 1B could represent a group of pillars in a meta-lens. In the illustrated example of FIG. 1B, the pillars 136A, 136B, 136C can provide different phase delays to incoming light. For example, light passing through pillar 136B will experience a larger phase delay than pillar 136A or pillar 136C. In some cases, the pillars 136A, 136B, 136C can represent groups of pillars that provide different phases delays to incoming light. In the illustrated example of FIG. 1B, light rays 134A, 134B, 134C can be incident upon the meta-lens 130. In the illustrated example of FIG. 1B, light ray 134A passes through a first pillar 136A, light ray 134B passes through a second pillar 136B, and light ray 134C passes through a third pillar 136C. The light rays 138A, 138B, 138C represent the path of light rays 134A, 134B, 134C after passing through the respective pillars 136A, 136B, 136C. As illustrated in FIG. 1B, the rays 138A and 138C travel from edges of the meta-lens 130 and can travel a greater distance than the ray 138B to reach the focal point 132. In some implementations, each of the pillars 136A, 136B, 136C can be configured with a phase shift such that each of the rays 138A, 138B, 138C arrive at the focal point 132 with an identical phase. As will be explained with more detail below with respect to FIG. 1C through FIG. 1E, the phase shift experienced by light rays (e.g., 134A, 134B, 134C) passing through the pillars 136A, 136B, 136C can be controlled as a function of the geometry of the pillars 136A, 136B, 136C. In some cases, an amount of phase shift experienced by light passing through the pillar 118 can depend on the height H, the diameter D, the wavelength of the light, the angle of incidence, and the polarization of the light passing through the pillar.

FIG. 1C illustrates a perspective view and FIG. 1D illustrates a top-down view of a unit cell that can be used for designing a meta-lens (such as meta-lens 100) with desired optical characteristics. In the illustration of FIG. 1C and FIG. 1D, the unit cell 114 can include a base 116, which can be a portion of the substrate 102 of the meta-lens 100 shown in FIG. 1A. In some cases, the base 116 includes a pillar 118 disposed upon the base 116 and centered at the center of the unit cell 114. In some aspects, the unit cell can be a square, triangular, hexagonal, or other geometric tile shape with a width of U. As an example, FIG. 1F illustrates an example meta-lens 190 having a triangular lattice unit cell 192. In some implementations, the width U of the unit cell can be determined based on the wavelength (λ) of light that the meta-lens is designed for. In some cases, the width U can be less than λ/(−2*NA) where NA is the numerical aperture of the meta-lens. In some cases, the width U of a unit cell can be between 300 nm and 600 nm. The pillar 118 can have a height of H and a diameter of D. In some cases, the optical characteristics of each unit cell 114 can be configured based on the value selected for the value D of each unit cell. In some cases, a meta-lens can be constructed by arranging an array (also referred to as a lattice) of unit cells having pillars 118 of different diameters to achieve desired optical characteristics. In the case where each of the unit cells has an identical value of U, the pillars 118 can have a uniform pitch. Although a square unit cell and associated lattice are described herein with respect to FIGS. 1C and 1D, other unit cell shapes and lattice structures can be utilized without departing from the scope of the present disclosure. In one illustrative example, a hexagonal unit cell can be used to form a hexagonal or triangle lattice.

FIG. 1E illustrates multiple plots 150 of phase shift for light traveling through pillars of different diameters D. The illustrative example of FIG. 1E depicts the relationship between diameter and phase for transverse electric (TE) polarized light passing through the pillar 118. In the illustrated example of FIG. 1E, the horizontal axis represents diameter D in microns (μm) of a pillar 118 in a unit cell 114 and the vertical axis represents the amount of phase shift experienced by light that has passed through the pillar 118. The multiple plots 150 illustrate the amount of phase shift experienced by light for different angles of incidence theta. As shown in FIG. 1E, for a fixed pillar height H, the phase shift for light passing through the pillar 118 can increase as the diameter D of the pillar 118 increases.

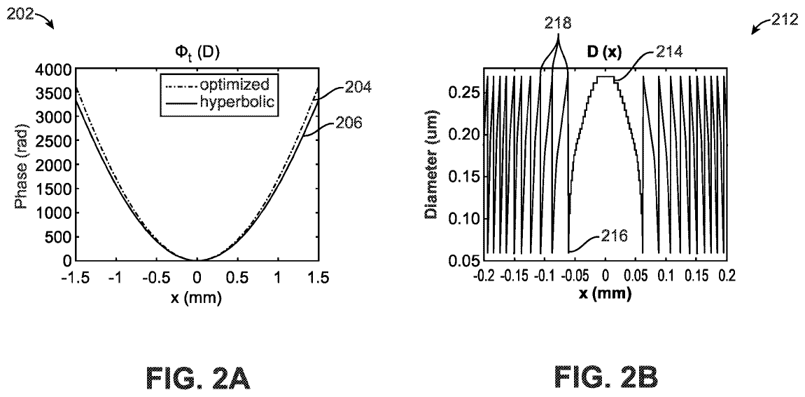

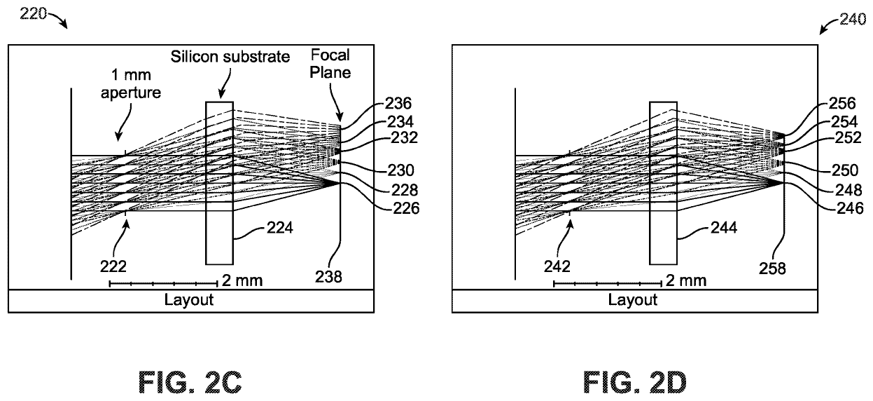

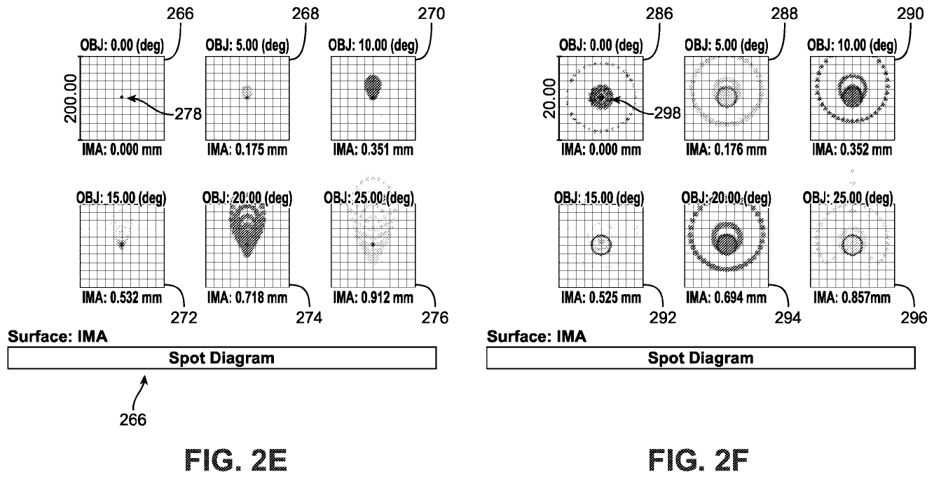

FIG. 2A illustrates a plot 202 of an example relationship between distance from the center of a meta-lens (e.g., meta-lens 100 shown in FIG. 1A) and an amount of phase shift for two example positive meta-lenses. In the illustrated examples of FIG. 2A and FIG. 2B, the meta-lens can be formed with an array unit cells (e.g., unit cell 114 shown in FIG. 1C and FIG. 1D above) having fixed height and width U and pillars of uniform height. In one illustrative example, the relationship between diameter D of the pillars included in the unit cells corresponds to the plots 150 shown in FIG. 1E above. In the illustrated example of FIG. 2A, the horizontal axis represents a distance from the center of the meta-lens and the vertical axis represents a phase shift to be imparted by at each distance to achieve particular desired meta-lens optical characteristics. The example plot 206 represents an example of pillar sizes for a meta-lens that is designed with optical characteristics of a hyperbolic refractive lens. In one illustrative example, the hyperbolic refractive lens relationship between phase and distance from the center of the lens illustrated by example plot 206 can represent a hyperbolic lens that provides an exact focus for normally incident light. The example plot 204 illustrates an example of an optimized meta-lens having a desired set of optical characteristics. In some cases, optimized characteristics for a meta-lens can be determined using an optical ray-tracing software. For example, the example plot 204 can represent a lens optimized to minimize an optical path difference (OPD) over a range of angles of incidence between 0 and 25 degrees. In one illustrative example, the lens represented by example plot 204 can be the result of an optimization of Equation (1) below.

$$OPD ( r ) = {a}_{0} ( \sqrt{{r}^{2} + {f}^{2}} - f ) + {\sum }_{m = 2}^{10} {a}_{m} {r}^{m} \qquad ( 1 )$$

Where r is the radial position on the meta-lens, f, is the focal length normalized by the meta-lens, a₀ is a term controlling the ratio of the hyperbolic phase law with respect to the aspherical terms, and am are coefficients that are adjusted to determine the optimized OPD. In some cases, do can also be used to adapt to different material. For instance, to design a metalens focusing a normally incident beam into air, a₀=1, into glass a₀=1.5 and into Silicon a₀=3.5. The sign of a₀ may become negative to model diverging lenses. As will be illustrated with respect to FIG. 2C through FIG. 2F below, optimizing the OPD can improve focusing for ray angles that are not normally incident to the meta-lens.

As described with respect to FIG. 1A through FIG. 1E above, an example meta-lens can be configured such that any incident ray passing through pillars (e.g., pillars 118) of the meta-lens can arrive at a focal point with an identical phase. In the illustration of FIG. 2A, the horizontal axis of the plot 202 represents a distance in millimeter (mm) from the center of the meta-lens and the vertical axis of the plot 202 represents an amount of phase shift in radians required to achieve the desired optical characteristics for the example meta-lens.

FIG. 2B illustrates a plot 212 of meta-lens pillar diameter plotted against distance from the center of a meta-lens. In the illustrated example of FIG. 2B, the horizontal axis represents a distance from the center of the meta-lens and the vertical axis represents a diameter of a pillar to achieve particular meta-lens optical characteristics. The example pillar diameters shown in FIG. 2B correspond to the plot 202 of the optimized meta-lens described above with respect to FIG. 2A. Because the propagation of light can be described as a sinusoid, the phase of the light can repeat every period of the wavelength of the light (e.g., every 360 degrees or every 2×pi (π) radians). As a result, the same pillar diameter can be used when, for example, the desired phase shift is 180 degrees as well as when the desired phase shift is 540 degrees. Accordingly, the plot 212 illustrates a range of pillar diameters that can provide phase shifts that correspond to the example plot 204 of an optimized meta-lens. In the illustrated example, the diameter D can have a maximum value at the center 214 of the meta-lens. In some cases, as the distance from the center 214 of the meta-lens increases, the diameter D of the pillars in the unit cells can decrease until a minimum diameter 216 is reached. At the distance from the center 214 of the meta-lens corresponding to the minimum diameter 216, the desired phase shift for the pillars can be 2 π radians separated from than the desired phase shift for the pillars at the center 214 of the meta-lens. In some cases, at each point where the desired phase shift is a multiple of 2 π radians separated from the phase shift from the pillars at the center 214 of the meta-lens, the diameter D of the pillars can be reset to the largest size. In some cases, the locations where the pillar diameter D resets to the largest value can be referred to as phase reset points 218.

FIG. 2C illustrates an example ray diagram 220 for a hyperbolic meta-lens. In one illustrative example, the hyperbolic lens shown in the ray diagram 220 can correspond to the example hyperbolic lens phase characteristics shown in example plot 206 of FIG. 2A above. FIG. 2C illustrates an aperture 222, a meta-lens 224, and light rays 226, 228, 230, 232, 234, 236. In the illustrated example of FIG. 2C, light rays 226 have an angle of incidence of 0 degrees, light rays 228 have an angle of incidence of 5 degrees, light rays 230 have an angle of incidence of 10 degrees, light rays 232 have an angle of incidence of 15 degrees, light rays 234 have an angle of incidence of 20 degrees, and light rays 236 have an angle of incidence of 25 degrees. As shown in FIG. 2C, the light rays 226, 228, 230, 232, 234, 236 show an increasing amount of spread at the focal plane 238 as the angle of incidence increases.

FIG. 2D illustrates an example ray diagram 240 for an optimized meta-lens configuration. In the illustrated example, the lens configuration can be optimized for wide-angle performance. In one illustrative example, the optimized meta-lens 244 shown in the ray diagram 240 can correspond to the example optimized lens phase characteristics shown in example plot 204 shown in FIG. 2A above. FIG. 2D illustrates an aperture 242, a meta-lens 244, and light rays 246, 248, 250, 252, 254, 256. In the illustrated example of FIG. 2D, light rays 246 can have an angle of incidence of 0 degrees, light rays 248 can have an angle of incidence of 5 degrees, light rays 250 can have an angle of incidence of 10 degrees, light rays 252 can have an angle of incidence of 15 degrees, light rays 254 can have an angle of incidence of 20 degrees, and light rays 256 can have an angle of incidence of 25 degrees. As shown in FIG. 2D, the light rays 246, 248, 250, 252, 254, 256 show a relatively reduced amount of spread at the focal plane 258 when compared to the light rays 226, 228, 230, 232, 234, 236 shown in FIG. 2C.

In one illustrative example, the example meta-lenses 224 and 244 shown in FIG. 2C and FIG. 2D, respectively, can represent meta-lenses configured as follows: the meta-lenses 224 and 244 can be designed for a wavelength of 1380 nm or 1550 nm; the apertures 222 and 242 can have a 1 mm diameter; a spacing between the apertures 222, 242 and the respective meta-lenses 224, 244 can be 1.5 mm; the meta-lenses 224, 244 can be fabricated on a 0.5 mm thick crystalline silicon wafer substrate; and the meta-lenses 224, 244 can have a focal length of 2 mm.

FIG. 2E illustrates spot diagrams at the focal plane 238 for the light rays 226, 228, 230, 232, 234, 236 passing through meta-lens 224 as shown in FIG. 2C. In the spot diagrams 266, 268, 270, 272, 274, 276 the plotted grids represent an area with dimensions 200 μm×200 μm and the center of each grid can correspond to ideal focal point at the focal plane (e.g., focal plane 238 shown in FIG. 2C). In the illustration of FIG. 2E, each of the spot diagrams 266, 268, 270, 272, 274, 276 includes a circle representing the diffraction limit for focusing the incident light at the focal plane. For example, circle 278 (which may appear as a dot) shows the diffraction limit illustrated on the spot diagram 266. Each of the remaining spot diagrams 268, 270, 272, 274, 276 include a similar circle (not labeled). As shown in FIG. 2E, spot diagram 266 can correspond to light rays 226 with a 0 degree angle of incidence, spot diagram 268 can correspond to light rays 228 with a 5 degree angle of incidence, spot diagram 270 can correspond to light rays 230 with a 10 degree angle of incidence, spot diagram 272 can correspond to light rays 232 with a 15 degree angle of incidence, spot diagram 274 can correspond to light rays 234 with a 20 degree angle of incidence, and spot diagram 276 can correspond to light rays 236 with a 25 degree angle of incidence. In the illustrated spot diagrams 266, 268, 270, 272, 274, 276, the dots represent the location on the focal plane (e.g., focal plane 238 shown in FIG. 2C) of rays passing through different portions of the meta-lens 224. As shown in the spot diagram 266, the hyperbolic meta-lens 224 can provide an ideal focus at 0 angle of incidence. However, as shown in spot diagrams 268, 270, 272, 274, 276 as the angle of incidence increases, the amount of spread also increases. As shown in spot diagram 276, some light rays with an angle of incidence of 25 degrees can arrive at the focal plane over 100 μm from the ideal focal point on the focal plane.

FIG. 2F illustrates spot diagrams at the focal plane for the light rays 246, 248, 250, 252, 254, 256 passing through meta-lens 244 as shown in FIG. 2D. In the spot diagrams 286, 288, 290, 292, 294, 296 the plotted grids represent an area with dimensions 20 μm×20 μm and the center of each grid can correspond to the center of the focal plane (e.g., focal plane 258 shown in FIG. 2D). In the illustration of FIG. 2F, each of the spot diagrams 286, 288, 290, 292, 294, 296 includes a circle representing the diffraction limit for focusing the incident light. For example, circle 298 shows the diffraction limit illustrated on the spot diagram 286. Each of the remaining spot diagrams 288, 290, 292, 294, 296 include a similar circle (not labeled). As shown in FIG. 2F, spot diagram 286 can correspond to light rays 246 with a 0 degree angle of incidence, spot diagram 288 can correspond to light rays 248 with a 5 degree angle of incidence, spot diagram 290 can correspond to light rays 250 with a 10 degree angle of incidence, spot diagram 292 can correspond to light rays 252 with a 15 degree angle of incidence, spot diagram 294 can correspond to light rays 254 with a 20 degree angle of incidence, and spot diagram 296 can correspond to light rays 256 with a 25 degree angle of incidence. In the illustrated spot diagrams 286, 288, 290, 292, 294, 296, the dots represent the location on the focal plane (e.g., focal plane 258 shown in FIG. 2D) of rays passing through different portions of the meta-lens 244. As shown in the spot diagram 286, the optimized meta-lens 244 can provide an ideal focus at 0 angle of incidence. As shown in spot diagrams 288, 290, 292, 294, 296 as the angle of incidence increases, the amount of spread increases by only a small degree when compared to the spot diagrams hyperbolic lens spot diagrams illustrated 266, 268, 270, 272, 274, 276 in FIG. 2E. As shown, in spot diagrams 288, 290, 292, 294, 296, the rays passing through the optimized meta-lens 244 can be focused within a 10 μm radius in any direction from the ideal focal point on the focal plane.

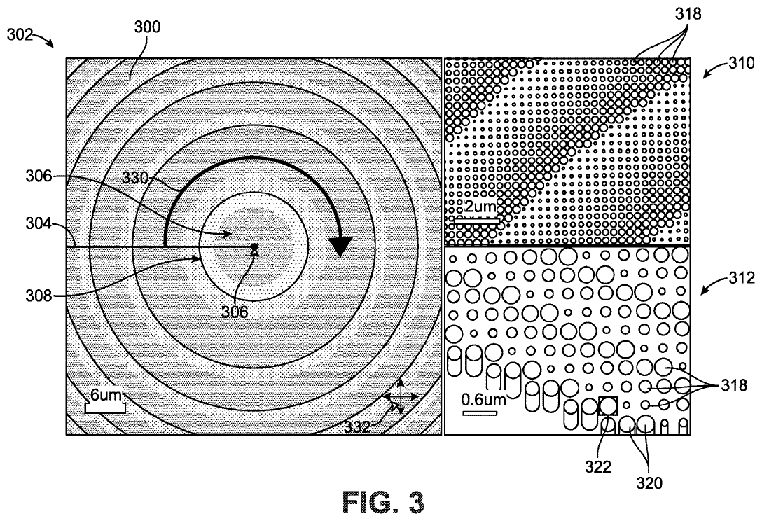

FIG. 3 illustrates example magnified portions of a meta-lens 300 illustrating a pattern of unit cells with varying pillar diameters. In FIG. 3, the meta-lens 300 is disposed on a lens plane 332 and an optical axis extends perpendicular to the lens plane 332 (e.g., extending out from and back through the lens plane 332) from a center 306 of the meta-lens 300. In one illustrative example, the pillar sizes of meta-lens 300 can correspond to the example meta-lens illustrated in plot 212 shown in FIG. 2B. As illustrated in FIG. 3, a low magnification level view 302 of the meta-lens 300 shows that the pattern of pillars 318 (which can correspond to pillars 118 shown in FIG. 1C and FIG. 1D above) of the meta-lens 300 can have a rotationally symmetric pattern 330 around an optical axis from the center 306 of the meta-lens 300 to the periphery of the meta-lens 300. In some cases, the optical axis may be at the center 306 of the meta-lens 300. In the illustration of FIG. 3, a line segment 304 extending radially from the center 306 of the meta-lens 300 is drawn. As shown in the plot 212 of FIG. 2B, near the center 306 of the meta-lens 300, the diameter of the pillars 318 can have a maximum value. In one illustrative example, the diameter of the pillars 318 at the center of the meta-lens 300 can be approximately equal to or slightly smaller than the width U of a unit cell (e.g., unit cell 114 as shown in FIG. 1C and FIG. 1D). Moving away from the center 306 of the meta-lens 300, the pillar size can decrease (providing a correspondingly smaller phase shift) relative to the pillars at the center 306 of the meta-lens until a phase reset point 308 (e.g., phase reset points 218 shown in FIG. 2B) is reached. At the phase reset point 308, the size of the pillars 318 can be reset to the largest diameter. In some cases, the varying diameters of the pillars 318 can create a ring-like appearance. The medium magnification level 310 and high magnification level 312 further illustrate the appearance of the pillars within the unit cells. As illustrated, the pillars 318 can be centered on a common pitch and large pillars 320 can have a diameter slightly smaller than the width U of a unit cell 322 (depicted as a white square).

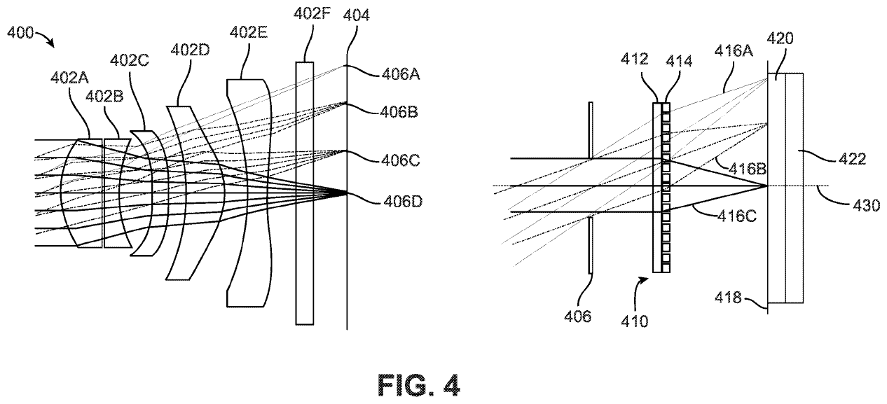

FIG. 4 illustrates lateral views of a compound lens 400 and a corresponding meta-lens 410 that can have similar optical characteristics. In the illustration of FIG. 4, the compound lens 400 includes lens elements 402A, 402B, 402C, 402D, 402E, and a sensor cover glass 402F that when stacked together can provide desired optical characteristics for a particular application. For example, the compound lens 400 can be designed with a particular target focal range, a wide angle field of view, and desired upper limit amounts of spherical aberration and chromatic aberration, among other characteristics. In the compound lens 400, the various optical elements 402A, 402B, 402C, 402D, 402E, 402F can each refract incoming light rays 406A, 406B, 406C, 406D in different ways such that the overall effect of the optical elements 402A, 402B, 402C, 402D, 402E, 402F, when stacked together, provides the desired optical performance. In the illustrated example, the compound lens 400 can operate to focus the incoming light rays 406A, 406B, 406D, 406D at the focal plane 404. In some examples, an optical sensor (also referred to as an image sensor, image detector, or light sensitive device herein) can be positioned at the focal plane 404 to detect the incoming light. Because multiple elements can be required to achieve the desired characteristics of the compound lens 400, the compound lens can add significant height, weight, and/or cost to a device using the compound lens 400 (e.g., a mobile device). In some cases, a device may have more than one camera as well as other optical sensors, each of which may require multiple separate compound lenses.

In some cases, a meta-lens 410 can be configured to perform with similar optical characteristics to the compound lens 400. In some implementations, a single layer meta-lens 410 can provide the desired optical characteristics for an imaging system (e.g., a camera, a range imager, or the like). In such cases, the meta-lens 410 can provide substantial savings in weight and thickness relative to the compound lens 400. The meta-lens 410 can include a substrate 412 and pillars 414 (e.g., pillars 118 shown in FIG. 1A, FIG. 1C and FIG. 1D) disposed (e.g., etched into) on the substrate 412. In some cases, light rays 416A, 416B, and 416C can arrive at the meta-lens 410 from different angles after passing through an aperture 406. The light rays 416A, 416B, and 416C may propagate through the lens along a path around an optical axis 430. The optical axis 430 may be at a center of the meta-lens 410. In some cases, the varying sizes (e.g., diameter, heights, pitch, etc.) of the pillars 414 may control the transmission, polarization, phase/delays of the incoming light by varying an effective refractive index. In some cases, the meta-lens 410 may include pillars 414 configured to focus collimated incident light into a spot on a focal plane 418. In some cases, the pillars 414 at position (x,y) may be configured to impart a phase (e.g., delay) given by φₜ(x,y) to compensate for the path difference between the rays. As a result, all rays travel to the point O on the focal plane 418 at the same time. As illustrated in FIG. 4., the meta-lens 410 can focus the light at the focal plane 418. In some examples, an optical sensor 420 can be positioned at the focal plane 418 to detect the incoming light. In some cases, the optical sensor 420 may be a silicon based sensor. In some examples, the optical sensor 420 may be stacked on top of and coupled to a control and processing circuit 422. In some cases, the control and processing circuit 422 can provide control signals to the optical sensor 420. In some aspects, the control and processing circuit 422 can further provide timing signals to other components in a device that incorporates the meta-lens 410 and optical sensor 420.

In some cases, the control and processing circuit 422 can be used to perform local image processing operations without requiring transferring image data over a bus to a processing unit. In some cases, the control and processing circuit 422 can generate depth maps, stitch together multiple frames (or portions of frames) of image data, generate composite images from multiple captured images (or portions of images), as well as performing other image processing operations. Thus, the control and processing circuit 422 may include at least one processor coupled to a memory and disposed on a substrate. The control and processing circuit 422 may be mechanically coupled to the optical sensor 420. As described above, in some cases, the control and processing circuit 422, optical sensor 420, and meta-lens 410 may be fabricated using a semiconductor manufacturing process and assembled in a single wafer stacking process.

As discussed above, in some cases, meta-lens 410 may be fabricated from silicon materials, such as silicon wafers, and may be relatively small. In some cases, a silicon based meta-lens 410, in SWIR wavelengths, may have a relatively high optical index as compared to, for example, air or glass. This high optical index allows light to be focused into a very sharp (e.g., small) focal spot, producing a relatively small image. As an example, by using a limited number of stacked meta-lenses (e.g., 1 to 3 meta-lenses stacked in a manner similar to lens 402A-402F), in SWIR wavelengths, may produce an image less than 0.4 mm wide on an image sensor plane. In comparison, an image sensor for a camera on a typical smartphone may be about 5-9 mm wide. In some cases, as a meta-lens and images produced by meta-lens can be substantially smaller than a comparable conventional lens, it may be useful to form an array of multiple, adjacent, compact meta-lenses. The array of meta-lenses can form multiple images on a single image sensor. Such an arrangement may allow a single image sensor to produce multiple images. This single image sensor may be stacked on top of, or otherwise integrated with, a control and processing circuit. The control and processing circuit may process the multiple images produced by the image sensor to compute depth information and/or light field information, which may allow the single image sensor to perform, for example, stereo sensing and/or plenoptic sensing.

Plenoptic sensing, otherwise known as light field sensing, allows an imaging device to capture information about a light intensity of a scene and information about directions light rays are travelling. Based on the light intensity and direction information, a plenoptic sensor may determine information about where light rays are emanating from and this information may be used to reconstruct depth information about the environment. Thus, plenoptic sensing may be useful for computer vision/image processing tasks as plenoptic sensing may allow for an entire scene in an image to be in focus and can provide depth information for object in the scene without relying on multiple cameras.

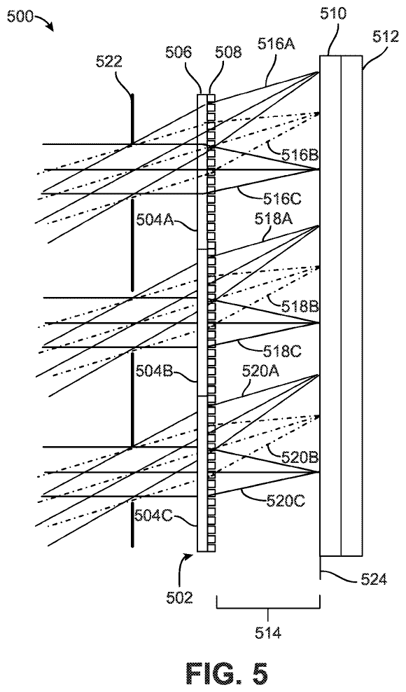

FIG. 5 illustrates a lateral view of an imaging system 500 including a meta-lens array, in accordance with aspects of the present disclosure. System 500 includes a meta-lens array 502, which includes a plurality of meta-lenses 504A, 504B, and 504C. The meta-lens array 502 may be silicon based and may include a substrate 506 and pillars 508 (e.g., pillars 118 shown in FIG. 1A, FIG. 1C and FIG. 1D). In some cases, the pillars 508 may be disposed (e.g., etched) into the substrate 506. The meta-lens array 502 may be separated from an image sensor 510 positioned on a focal plane 524 via a gap 514. A single image sensor may be used for the meta-lenses 504A-504C of the meta-lens array 502. As with meta-lens 410 of FIG. 4, the image sensor 510 may be stacked on top of and coupled to a control and processing circuit 512. In some cases, the gap 514 may be created using one or more spacers. In some cases, gap 514 may be filled with air. In some cases, the gap 514 may be filled with another material, such as glass or silicon, which may provide a higher refractive index as compared to air. In some cases, multiple materials may be used to fill gap 514. The selection of the material(s) used to fill gap 514 may be based on a desired refractive index.

In a manner similar to that described above with respect to FIG. 4, each meta-lens 504A-504C of the meta-lens array 502 may receive light rays 516A, 516B, light rays 516C, 518A, 518B, and 518C, and light rays 520A, 520B, and 520C, respectively, through an aperture 522 from different angles. Pillars 508 of the meta-lenses 504A-504C may control the transmission, polarization, phase/delays of the incoming light to focus light onto spots on the image sensor 510.

In some cases, each meta-lens 504A-504C may focus light onto specific predetermined (e.g., mapped) locations of the image sensor 510. Thus, a single image sensor 510 may be able to capture an image with sub-images associated with each meta-lenses 504A-504C via a single read out of the image sensor 510. The sub-images from each of meta-lenses 504A-504C are captured at a different angle from the scene. Thus, each sub-image from the meta-lenses 504A-504C is different and objects do not appear in the same location in each sub-image based on the object's distance to an area of the image sensor 510 associated with the different meta-lenses 504A-504C. This difference between images can provide disparity information.

In some cases, this disparity between the sub-images captured by the meta-lens array 502 may be used to determine information about the light field and/or depth information from the environment. For example, differences between correlated points in the sub-images captured may be used to determine direction information for a light ray reflecting off of a surface in the environment. In some cases, the direction information may be combined with light intensity information (e.g., brightness) to provide the light field for a light field image generated based off of the sub-images produced by the meta-lenses 504A-504C and the image sensor 510. In some cases, the control and processing circuit 512 may process image information read out from the image sensor 510 captured via the meta-lens array 502 to generate the light field image. In some cases, generating the light field image may be performed based on a plenoptic function. The plenoptic function may be a five dimensional function that describes an intensity of light rays, along position and direction information about the light rays for a scene.

In some cases, the disparity information may be used to provide depth information for the scene captured in an image. For example, depth from stereo may be used to determine depth information based on the differences in location of objects in the scene. This depth information may be used to, for example, provide anchor points, provide pose estimation/6 degree of freedom information, and the like.

Of note, while the meta-lens array 502 in imaging system 500 is illustrated as including three meta-lenses 504A-504C in a one-dimensional arrangement, it may be understood that the meta-lens array 502 may include any number of meta-lenses 504A-504C and these meta-lenses 504A-504C may be arranged in a two-dimensional or three-dimensional arrangement. In some cases, the arrangement of meta-lenses 504A-504C in the meta-lens array 502 may be based on a shape of the image sensor 510. In some cases, the meta-lenses 504A-504C may be any shape. For example, the meta-lenses 504A-504C may be square shaped to help maximize image sensor 510 utilization. In some cases, the meta-lenses 504A-504C may include multiple layers of meta-lenses.

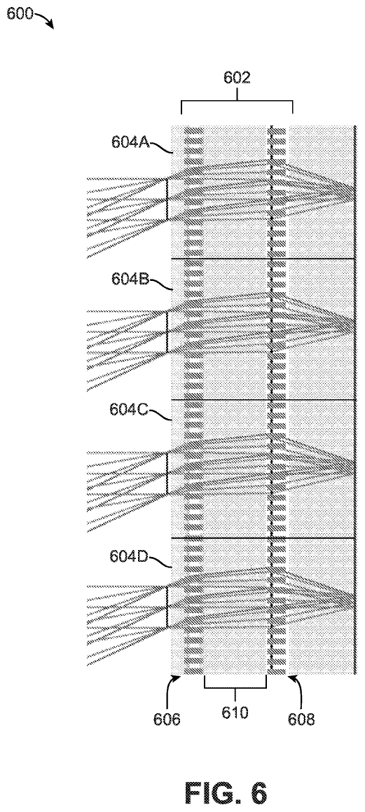

FIG. 6 illustrates a lateral view of an imaging system 600 including a meta-lens array with multi-layer meta-lenses, in accordance with aspects of the present disclosure. Imaging system 600 includes a meta-lens array 602 with four meta-lenses 604A, 604B, 604C, and 604D. In meta-lens array 602, each meta-lens 604A-604D is a two layer meta-lens with a first layer 606 and a second layer 608. Of note, such an arrangement may also be referred to as two stacked meta-lens arrays or as a two layer meta-lens array. In some cases, the layers, such as the first layer 606 and second layer 608, may be separated by a gap 610. In other cases, the layers may be directly stacked together. In some cases, the gap 610 may be filled with any material, examples of which may include air, silicon, glass, and the like. In some cases, multiple materials may be used to fill gap 610. The selection of the material(s) used to fill gap 610 may be based on a desired refractive index. In some cases, multi-layer meta-lenses may allow for lower effective focal lengths for a particular axial length (e.g., distance between the meta-lenses and focal plane 612), allowing for more compact (e.g., thinner) meta-lens imaging systems. Further, multi-layer meta-lenses may produce a more focused (e.g., smaller) image at the focal plane, as compared to a single layer meta-lens, which may allow for an increased number of meta-lenses for a given sized meta-lens array. In some cases, multi-layer meta-lenses may allow for aberration/distortion correction that may be difficult to achieve with a single layer meta-lens.

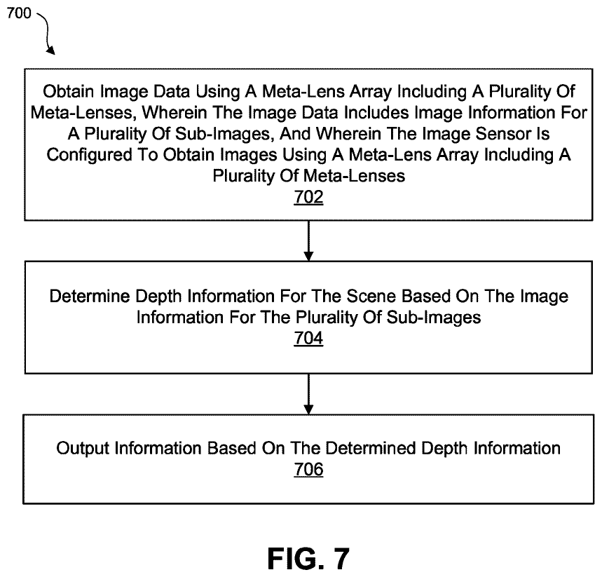

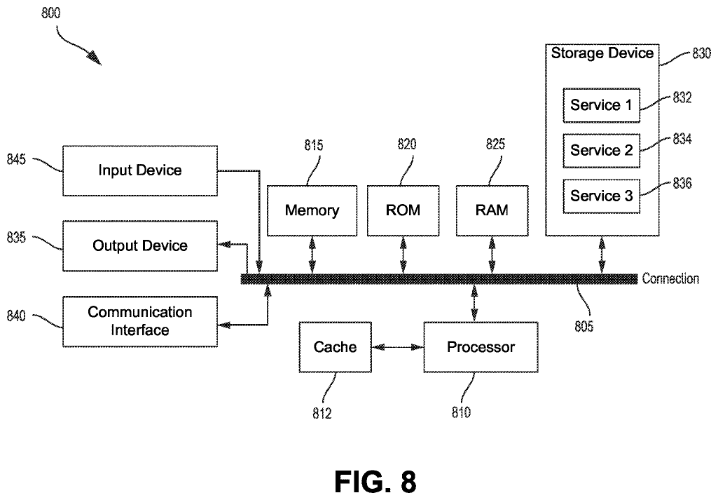

FIG. 7 is a flow diagram illustrating an example of a process 700 for image processing, in accordance with aspects of the present disclosure. The process 700 may be performed by a computing device (or apparatus) or a component (e.g., a chipset, codec, etc.) of the computing device, such as the processing circuit 512 of FIG. 5 or the processor 810 of FIG. 8. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., the processing circuit 512 of FIG. 5, the processor 810 of FIG. 10, and/or another processor(s)).

At block 702, the computing device (or component thereof) may obtain image data for a scene from the image sensor (e.g., optical sensor 420 of FIG. 4, image sensor 510 of FIG. 5). In some cases, the image data includes image information for a plurality of sub-images. In some cases, the image sensor is configured to obtain images using a meta-lens array (e.g., meta-lens array 502 of FIG. 5) including a plurality of meta-lenses (e.g., meta-lenses 504A, 504B, and 504C of FIG. 5). In some cases, the plurality of meta-lenses include a substrate layer (e.g., substrate 102 of FIG. 1A, substrate 412 of FIG. 4, substrate 506 of FIG. 5, and layers 606 and 608) with nanostructures (e.g., pillars 104, 106, 108, 118 of FIG. 1A, pillars 136A, 136B, 136C of FIG. 1B, pillar 118 if FIGS. 1C and 1D, pillars 318 of FIG. 3, pillars 414 of FIG. 4, and pillars 508 of FIG. 5) disposed on the substrate layer. In some cases, the nanostructures comprise a plurality of pillars. In some cases, the plurality of meta-lenses include a plurality of substrate layers (e.g., layers 606 and 608) with nanostructures disposed on the plurality of substrate layers. In some cases, the plurality of substrate layers are separated by one or more gaps (e.g., gap 610) between substrate layers. In some cases, the image sensor is disposed on a first substrate layer. In some cases, the at least one processor is disposed on a second substrate layer. In some cases, the first substrate layer is coupled to the second substrate layer in a stacked wafer. In some cases, each meta-lens of the plurality of meta-lenses is configured to produce a corresponding sub-image in a predetermined portion of the image sensor. In some cases, the image sensor comprises a single image sensor.

At block 704, the computing device (or component thereof) may determine depth information for the scene based on the image information for the plurality of sub-images. The computing device (or component thereof) may generate a plenoptic image based on the determined depth information and the plurality of sub-images.

At block 706, the computing device (or component thereof) may output information based on the determined depth information. The computing device (or component thereof) may output the information based on the depth information by outputting the plenoptic image. The computing device (or component thereof) may output the information based on the depth information by outputting depth information for the scene.

In some examples, the processes described herein (e.g., process 700 and/or other process described herein) may be performed by a computing device or apparatus. For instance, the computing system 800 shown in FIG. 8 can implement the one or more of the operations of the process 700 of FIG. 7 and/or other processes described herein. In some examples, computing system 800 shown in FIG. 8 can include a meta-lens camera module including meta-lens (e.g., meta-lens 100 shown in FIG. 1A) described herein.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the process 700 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Abstract 1. An apparatus comprising: a meta-lens array including a plurality of meta-lenses; an image sensor configured to obtain images using the meta-lens array; at least one memory; and at least one processor coupled to the at least one memory, wherein the at least one processor is configured to: obtain image data for a scene from the image sensor, wherein the image data includes image information for a plurality of sub-images; determine depth information for the scene based on the image information for the plurality of sub-images; and output information based on the determined depth information.

Abstract 2. The apparatus of Abstract 1, wherein the plurality of meta-lenses include a substrate layer with nanostructures disposed on the substrate layer.

Abstract 3. The apparatus of Abstract 2, wherein the nanostructures comprise a plurality of pillars.

Abstract 4. The apparatus of any of Abstracts 1-3, wherein the plurality of meta-lenses include a plurality of substrate layers with nanostructures disposed on the plurality of substrate layers.

Abstract 5. The apparatus of Abstract 4, wherein the plurality of substrate layers are separated by one or more gaps between substrate layers.

Abstract 6. The apparatus of any of Abstracts 1-5, wherein the at least one processor is further configured to generate a plenoptic image based on the determined depth information and the plurality of sub-images.

Abstract 7. The apparatus of Abstract 6, wherein, to output the information based on the depth information, the at least one processor is configured to output the plenoptic image.

Abstract 8. The apparatus of any of Abstracts 1-7, wherein the image sensor is disposed on a first substrate layer, wherein the at least one processor is disposed on a second substrate layer, and wherein the first substrate layer is coupled to the second substrate layer in a stacked wafer.

Abstract 9. The apparatus of any of Abstracts 1-8, wherein each meta-lens of the plurality of meta-lenses is configured to produce a corresponding sub-image in a predetermined portion of the image sensor.

Abstract 10. The apparatus of any of Abstracts 1-9, wherein the image sensor comprises a single image sensor.

Abstract 11. The apparatus of any of Abstracts 1-10, wherein, to output the information based on the depth information, the at least one processor is configured to output depth information for the scene.

Abstract 12. A method for image processing, comprising: obtaining image data for a scene from an image sensor, wherein the image data includes image information for a plurality of sub-images, and wherein the image sensor is configured to obtain images using a meta-lens array including a plurality of meta-lenses; determining depth information for the scene based on the image information for the plurality of sub-images; and outputting information based on the determined depth information.

Abstract 13. The method of Abstract 12, wherein the plurality of meta-lenses include a substrate layer with nanostructures disposed on the substrate layer.

Abstract 14. The method of Abstract 13, wherein the nanostructures comprise a plurality of pillars.

Abstract 15. The method of any of Abstracts 12-14, wherein the plurality of meta-lenses include a plurality of substrate layers with nanostructures disposed on the plurality of substrate layers.

Abstract 16. The method of Abstract 15, wherein the plurality of substrate layers are separated by one or more gaps between substrate layers.

Abstract 17. The method of any of Abstracts 12-16, further comprising generating a plenoptic image based on the determined depth information and the plurality of sub-images.

Abstract 18. The method of Abstract 17, wherein outputting the information based on the depth information comprises outputting the plenoptic image.

Abstract 19. The method of any of Abstracts 12-18, further comprising obtaining a sub-image associated with each meta-lens, wherein each meta-lens of the meta-lens array corresponds to a predetermined portion of the image sensor.

Abstract 20. The method of any of Abstracts 12-19, wherein the image sensor comprises a single image sensor.

Abstract 21. The method of any of Abstracts 12-20, wherein outputting the information based on the depth information comprises outputting depth information for the scene.

Abstract 22. A non-transitory computer-readable medium having stored thereon instructions that, when executed by at least one processor, cause the at least one processor to: obtain image data for a scene from an image sensor, wherein the image data includes image information for a plurality of sub-images, and wherein the image sensor is configured to obtain images using a meta-lens array including a plurality of meta-lenses; determine depth information for the scene based on the image information for the plurality of sub-images; and output information based on the determined depth information.

Abstract 23. The non-transitory computer-readable medium of Abstract 22, wherein the plurality of meta-lenses include a substrate layer with nanostructures disposed on the substrate layer.

Abstract 24. The non-transitory computer-readable medium of Abstract 23, wherein the nanostructures comprise a plurality of pillars.

Abstract 25. The non-transitory computer-readable medium of any of Abstracts 22-24, wherein the plurality of meta-lenses include a plurality of substrate layers with nanostructures disposed on the plurality of substrate layers.

Abstract 26. The non-transitory computer-readable medium of Abstract 25, wherein the plurality of substrate layers are separated by one or more gaps between substrate layers.

Abstract 27. The non-transitory computer-readable medium of any of Abstracts 22-26, wherein the instructions cause the at least one processor to generate a plenoptic image based on the determined depth information and the plurality of sub-images.

Abstract 28. The non-transitory computer-readable medium of Abstract 27, wherein, to output the information based on the depth information, the instructions cause the at least one processor to output the plenoptic image.

Abstract 29. The non-transitory computer-readable medium of any of Abstracts 22-28, wherein the image sensor is disposed on a first substrate layer, wherein the at least one processor is disposed on a second substrate layer, and wherein the first substrate layer is coupled to the second substrate layer in a stacked wafer.

Abstract 30. The non-transitory computer-readable medium of any of Abstracts 22-29, wherein each meta-lens of the plurality of meta-lenses is configured to produce a corresponding sub-image in a predetermined portion of the image sensor.

Aspect 31: A non-transitory computer-readable storage medium having stored thereon instructions which, when executed by one or more processors, cause the one or more processors to perform any of the operations of aspects 12 to 21.

Aspect 32: An apparatus comprising means for performing any of the operations of aspects 12 to 21.

1. An apparatus comprising:
a meta-lens array including a plurality of meta-lenses;
an image sensor configured to obtain images using the meta-lens array;
at least one memory; and
at least one processor coupled to the at least one memory, wherein the at least one processor is configured to:
obtain image data for a scene from the image sensor, wherein the image data includes image information for a plurality of sub-images;
determine depth information for the scene based on the image information for the plurality of sub-images; and
output information based on the determined depth information.

2. The apparatus of claim 1, wherein the plurality of meta-lenses include a substrate layer with nanostructures disposed on the substrate layer.

3. The apparatus of claim 2, wherein the nanostructures comprise a plurality of pillars.

4. The apparatus of claim 1, wherein the plurality of meta-lenses include a plurality of substrate layers with nanostructures disposed on the plurality of substrate layers.

5. The apparatus of claim 4, wherein the plurality of substrate layers are separated by one or more gaps between substrate layers.

6. The apparatus of claim 1, wherein the at least one processor is further configured to generate a plenoptic image based on the determined depth information and the plurality of sub-images.

7. The apparatus of claim 6, wherein, to output the information based on the depth information, the at least one processor is configured to output the plenoptic image.

8. The apparatus of claim 1, wherein the image sensor is disposed on a first substrate layer, wherein the at least one processor is disposed on a second substrate layer, and wherein the first substrate layer is coupled to the second substrate layer in a stacked wafer.

9. The apparatus of claim 1, wherein each meta-lens of the plurality of meta-lenses is configured to produce a corresponding sub-image in a predetermined portion of the image sensor.

10. The apparatus of claim 1, wherein the image sensor comprises a single image sensor.

11. The apparatus of claim 1, wherein, to output the information based on the depth information, the at least one processor is configured to output depth information for the scene.

12. A method for image processing, comprising:
obtaining image data for a scene from an image sensor, wherein the image data includes image information for a plurality of sub-images, and wherein the image sensor is configured to obtain images using a meta-lens array including a plurality of meta-lenses;
determining depth information for the scene based on the image information for the plurality of sub-images; and
outputting information based on the determined depth information.

13. The method of claim 12, wherein the plurality of meta-lenses include a substrate layer with nanostructures disposed on the substrate layer.

14. The method of claim 13, wherein the nanostructures comprise a plurality of pillars.

15. The method of claim 12, wherein the plurality of meta-lenses include a plurality of substrate layers with nanostructures disposed on the plurality of substrate layers.

16. The method of claim 15, wherein the plurality of substrate layers are separated by one or more gaps between substrate layers.

17. The method of claim 12, further comprising generating a plenoptic image based on the determined depth information and the plurality of sub-images.

18. The method of claim 17, wherein outputting the information based on the depth information comprises outputting the plenoptic image.

19. The method of claim 12, further comprising obtaining a sub-image associated with each meta-lens, wherein each meta-lens of the meta-lens array corresponds to a predetermined portion of the image sensor.

20. The method of claim 12, wherein the image sensor comprises a single image sensor.

21-30. (canceled)
